(19) United States
(12) Patent Application Publication
(10) Pub. No.: US 2021/0336889 A1
(43) Pub. Date: Oct. 28, 2021

(54) ARTIFICIAL-INTELLIGENCE-DRIVEN QUALITY-OF-SERVICE ENGINE

(71) Applicant: International Business Machines Corporation, Armonk, NY (US)

(72) Inventors: Hamza Yaswi, Sterling, VA (US); Caryn Leslie Woodruff, Raleigh, NC (US); Joseph Reyes, Pelham, NY (US); Marci Devorah Formato, Clintondale, NY (US)

(73) Assignee: International Business Machines Corporation, Armonk, NY (US)

(21) Appl. No.: 16/856,542

(22) Filed: Apr. 23, 2020

(51) Int. Cl. H04L 12/851; H04L 12/927; H04L 12/853; H04L 12/24; G06N 20/00; H04W 28/08

(52) U.S. Cl. CPC H04L 47/2441; H04L 47/2433; H04L 47/2408; H04W 28/0967; H04L 47/2416; H04L 41/0896; G06N 20/00; H04L 47/805

(57) ABSTRACT

A method for dynamically modifying quality-of-service tags for multiple data flows is disclosed. In one embodiment, such a method determines current bandwidth utilization for each of multiple data flows passing through a network, and determines acceptable bandwidth utilization for each of the multiple data flows. The method receives external information that, based on one or more rules, is used to adjust quality of service priorities for one or more of the data flows. Based on the external information, the method dynamically adjusts quality-of-service tags for data packets associated with the data flows, such that current bandwidth utilization is altered for at least one data flow of the multiple data flows without violating acceptable bandwidth utilization for each of the multiple data flows. A corresponding system and computer program product are also disclosed.

### BACKGROUND

### Field of the Invention

This invention relates to systems and methods for adjusting quality of service for different types of data traffic.

### Background of the Invention

Enterprise networks need to provide predictable and measurable performance for various types of data, such as voice, video, multimedia content, backup data, recovery data, and delay-sensitive data, that traverse a network. In order to ensure that specific performance requirements are met for different types of data, quality of service (QoS) tools may be used to manage and prioritize data traffic passing through a network. These quality of service tools may, among other things, reduce packet loss, latency, errors, out-of-order delivery, and jitter within packet-switched networks. Quality-of-service functionality may be implemented in networking components, such as routers and switches, to prioritize data traffic that passes through the components.

In practice, quality-of-service functionality may be implemented with various classes or groups that identify and prioritize data packets. Each packet may be marked with a quality-of-service tag that indicates its priority to a network component such as a router. When there is more traffic than a circuit can handle, the router may begin to drop packets that are labeled with lower priorities. Usually, real-time traffic such as voice data is assigned a highest priority, while backup data, replication data, point-in-time-copy data, point-of-sale-connection data, application synchronization data, and the like, is assigned a lower but still important priority. Other non-critical types of data may be assigned even lower priorities. The problem with conventional quality-of-service tools is that groups or classes of data are typically statically configured and there is no way to dynamically change the priority of data for specific applications or data-replication methods based on changing business needs, component failures, changing environmental conditions, and/or the like.

In view of the foregoing, what are needed are systems and methods to dynamically adjust quality-of-service tags for specific applications, data-replication methods, and other data flows. Ideally, such systems and methods will dynamically adjust the tags in response to changing business needs, component failures, changing environmental conditions, and/or the like. Further needed are techniques to use artificial intelligence to understand data flows and optimize the data flows based on historical and real-time data.

### SUMMARY

The invention has been developed in response to the present state of the art and, in particular, in response to the problems and needs in the art that have not yet been fully solved by currently available systems and methods. Accordingly, systems and methods have been developed to dynamically modify quality-of-service tags for different data flows. The features and advantages of the invention will become more fully apparent from the following description and appended claims, or may be learned by practice of the invention as set forth hereinafter.

Consistent with the foregoing, a method for dynamically modifying quality-of-service tags for multiple data flows is disclosed. In one embodiment, such a method determines current bandwidth utilization for each of multiple data flows passing through a network, and determines acceptable bandwidth utilization for each of the multiple data flows. The method receives external information that, based on one or more rules, is used to adjust quality of service priorities for one or more of the data flows. Based on the external information, the method dynamically adjusts quality-of-service tags for data packets associated with the data flows, such that current bandwidth utilization is altered for at least one data flow of the multiple data flows without violating acceptable bandwidth utilization for each of the multiple data flows.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing one example of a quality-of-service model;

FIG. 3 is a high-level block diagram showing an artificial-intelligence-based quality-of-service engine configured to dynamically modify quality-of-service tags for different data flows in response to different external information;

FIG. 4 is a high-level block diagram showing a three-tier algorithm for modifying quality-of-service tags;

FIG. 5A is a table showing standard rules for applying quality-of-service tags to different data flows;

FIG. 5B is a table showing standard event-based rules for applying quality-of-service tags to different data flows based on external information;

FIG. 6 is a flow diagram showing an exemplary scenario for dynamically adjusting quality-of-service tags in response to a system failure;

FIG. 7 is a flow diagram showing an exemplary scenario for dynamically adjusting quality-of-service tags in response to a cyber threat; and

FIG. 8 is a flow diagram showing an exemplary scenario for dynamically adjusting quality-of-service tags in response to multiple different events.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

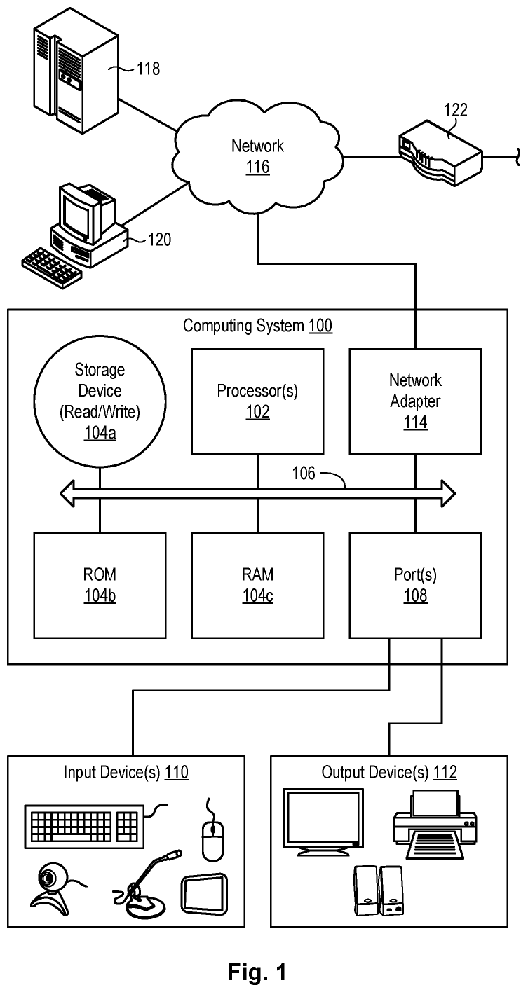

Referring to FIG. 1, one example of a computing system 100 is illustrated. The computing system 100 is presented to show one example of an environment where systems and methods in accordance with the invention may be implemented. The computing system 100 may be embodied as a desktop computer, a workstation, a laptop computer, a server, a storage controller, a mobile device 100 such as a smart phone or tablet, or the like. The computing system 100 is presented by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a local area network (LAN), wide area network (WAN), storage area network (SAN), or the Internet. Such a network 116 may enable the computing system 100 to connect to or communicate with one or more servers 118, workstations 120, personal computers 120, mobile computing devices, or other devices. The network 116 may also enable the computing system 100 to connect to or communicate with another network by way of a router 122 or other device 122. Such a router 122 may allow the computing system 100 to communicate with servers, workstations, personal computers, or other devices located on different networks.

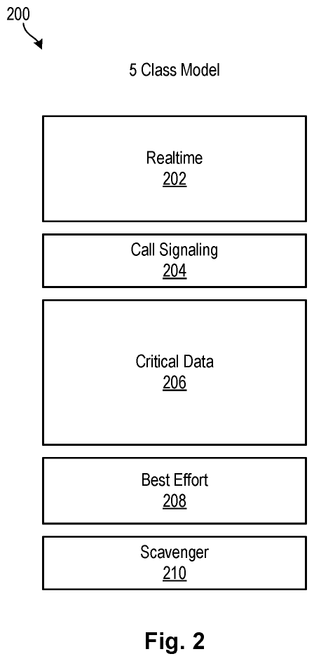

Referring to FIG. 2, as previously mentioned, enterprise networks need to provide predictable and measurable performance for various types of data, such as voice, video, multimedia content, and delay-sensitive data, that traverse a network. In order to ensure that specific performance requirements are met for different types of data, quality-of-service (QoS) tools may be used to manage and prioritize data traffic passing through a network 116. These quality-of-service tools may, among other things, reduce packet loss, latency, errors, out-of-order delivery, and jitter within packet-switched networks 116. Quality-of-service functionality may be implemented in networking components, such as routers 122 and switches, to prioritize data traffic that passes through the components.

In practice, quality-of-service functionality may be implemented with various classes or groups that identify and prioritize data packets. Each packet may be marked with a quality-of-service tag that indicates its priority to a network component such as a router 122. When there is more traffic than a circuit can handle, the router 122 may begin to drop packets that are labeled with the lowest priority. Usually, real-time traffic such as voice data is assigned a highest priority, while backup data, replication data, point-in-time-copy data, point-of-sale-connection data, application synchronization data, and the like, is assigned a lower but still important priority. Other non-critical types of data may be assigned even lower priorities. One problem with conventional quality-of-service tools is that groups or classes of data are typically statically configured and there is no way to change the priority of data for specific applications or data-replication methods based on changing business needs, component failures, changing environmental conditions, and/or the like.

FIG. 2 is a high-level block diagram showing one example of a quality-of-service model 200. As shown, the quality-of-service model 200 defines various groups 202-210 or classes 202-210 of traffic (i.e., data flows) that may pass through a network 116. In the illustrated example, the quality-of-service model 200 includes a realtime class 202, call signaling class 204, critical data class 206, best effort class 208, and scavenger class 210. Data associated with the realtime class 202 is given the highest priory while data associated with the scavenger class 210 is given the lowest priority. In certain embodiments, voice and/or video data may be assigned to the realtime class 202, while replication data, backup data, point-in-time-copy data, vmotion data (i.e., data associated with migrating virtual machines from one system to another), point-of-sale data, migration data, and the like, may be assigned to the critical data class 206. The best effort class 208 may be a default class that is assigned to data or an application unless it is assigned to another class. The scavenger class 210, by contrast, may be assigned to the least important or critical data. In the event of congestion on the network 116, data packets of the scavenger class 210 may be dropped most aggressively. The quality-of-service model 200 illustrated in FIG. 2 is simply one example of a quality-of-service model 200 and is not intended to be limiting. Other models 200 having more or fewer classes are possible and within the scope of the invention.

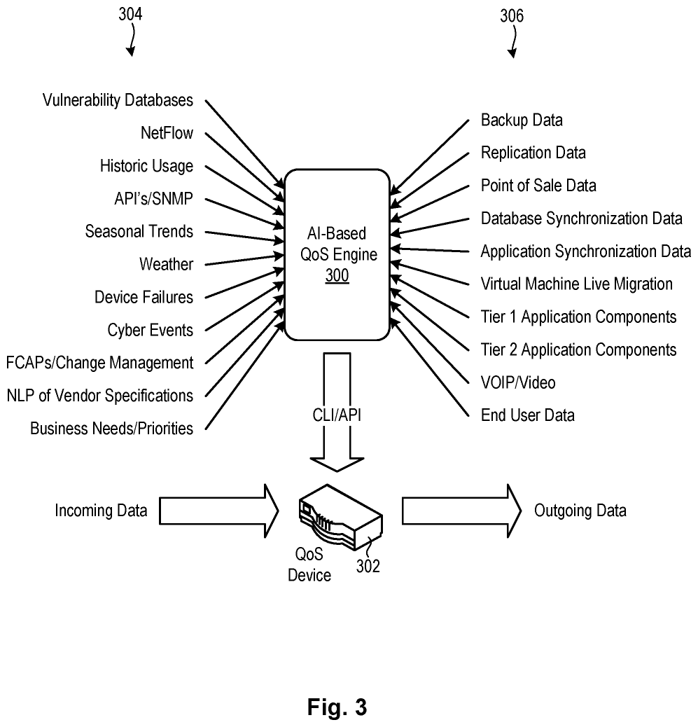

Referring to FIG. 3, in certain embodiments, an artificial-intelligence-based quality-of-service engine 300 (hereinafter referred to as an “AI-based QoS engine 300”) may be provided to dynamically modify quality-of-service tags for data flows passing through a network component 302, such as a router 122. In certain embodiments, the AI-based QoS engine 300 interfaces with the network component 302 by way of an application programming interface (API) or command-line interface (CLI) to dynamically change configuration settings of the network component 302 and thereby adjust quality-of-service tags for different data flows 306.

In certain embodiments, the AI-based QoS engine 300 tracks and/or analyzes various types of external information 304 that may be used to adjust quality-of-service tags. This external information 304 may include, for example, vulnerability databases that document previous or future threats (e.g., viruses, ransomware, etc.); NetFlow information that describes network traffic and communications between network components; historic usage information that describes past data usage and possibly predicts future usage; API and SNMP (Simple Network Management Protocol) information that may describe managed devices on networks and be used to change device behavior; seasonal trend information that describes data usage patterns during different times/seasons to identify when certain data flows 306 need to be prioritized; weather information to identify weather patterns that may affect data flows 306 or cause outages; device failure information that may create outages and thereby affect data flows 306; sentiment analysis that may identify potential future threats or cyber events; FCAPS and change management information that may identify components (servers, storage systems, etc.) that have been added or removed from a network environment; natural language processing (NLP) of vendor specifications or other information that may indicate ideal, minimum, or maximum bandwidth for various data flows 306; business need information that identifies data flows 306 that need to be prioritized to satisfy business needs; toolset information such as configuration management database (CMDB) information, change management information, and network management system (NMS) information; and original equipment manufacturer (OEM) best practice information.

Using the external information 304, the AI-based QoS engine 300 may adjust various data flows 306 through a network 116 by dynamically adjusting their quality-of-service tags. These data flows 306 may include, for example, flows of backup data, replication data, point-of-sale data, database synchronization data, application synchronization data, virtual machine migration data, tier 1 application component data (e.g., core application data), tier 2 application component data (e.g., non-core application data), voice-over-IP (VOIP) and/or video data, end-user data, and/or the like.

For example, using external information 304 such as vulnerability database or sentiment analysis, the AI-based QoS engine 300 may determine that a threat (e.g., virus or ransomware propagation) exists and prioritize data flows 306 such as patch installation data flows 306, backup data flows 306, point-in-time-copy data flows 306, or the like, to protect against the threats and/or ensure that recovery is possible from the threats. In another example, using external information 304 such as weather information, the AI-based QoS engine 300 may determine that a storm (e.g., tornado, hurricane) is advancing toward certain geographical locations. In response, the AI-based QoS engine 300 may re-prioritize certain data flows 306 such as data replication data flows 306, backup data flows 306, or the like, to ensure that data is protected and/or routed away from the impacted geographical locations. In another example, the AI-based QoS engine 300 may learn seasonal trends (e.g., Black Friday sales, Day After Christmas sales, etc.) and adjust the priority of data flows 306 such as point-of-sale data to ensure that demand can be met. In yet another example, the AI-based QoS engine 300 may use statistics to predict future device failures (storage device failures, etc.) and dynamically adjust data flows 306 such as backup data flows 306 to ensure that data is protected and recovery is possible from the failures. In another example, when an application fails and needs to be restored from another location across a network 116, the AI-based QoS engine 300 may increase the priority of data flows 306 needed to quickly restore the application. These represent just a few examples of how the AI-based QoS engine 300 may use external information 304 to adjust the priority of different data flows 306.

Because bandwidth on a network 116 may be limited, whenever the AI-based QoS engine 300 raises the priority of certain data flows 306, it may also in some cases need to reduce the priority of other data flows 306 to balance bandwidth usage. In certain embodiments, the AI-based QoS engine 300 may use natural language processing to analyze vendor specifications or other information for certain applications or data to ensure that bandwidth for these applications or data is not above or below acceptable limits after changes are made. Thus, in certain embodiments, the AI-based QoS engine 300 may dynamically adjust quality-of-service tags for data packets associated with certain data flows 306 based on external information 304, such that current bandwidth utilization is altered (e.g., raised, lowered) for at least one data flow 306 without violating acceptable bandwidth utilization for other data flows 306 flowing through the network 116.

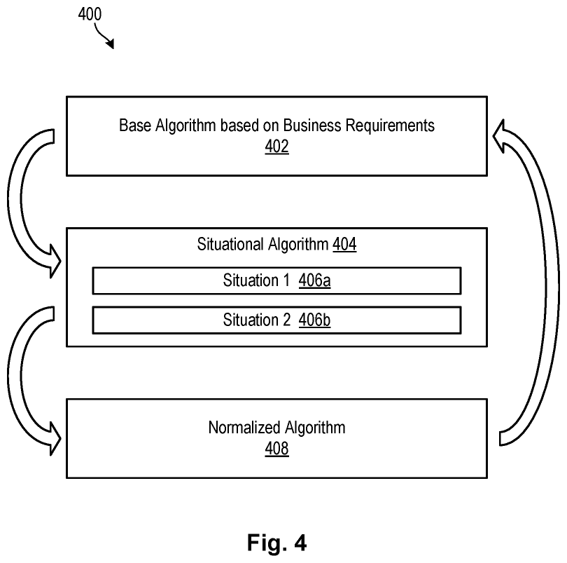

Referring to FIG. 4, a high-level block diagram showing a three-tiered algorithm 400 for modifying quality-of-service tags is illustrated. This three-tiered algorithm may be executed by the AI-based QoS engine 300 previously described. As shown, the three-tiered algorithm may start with a base algorithm 402 that establishes initial quality-of-service priorities for various types of data flows 306 based on business or other requirements. A situational algorithm 404 may then be executed that analyzes various types of situations 406 (e.g., weather events, cyber events, device failures, historic usage, seasonal usage, business needs, network modifications, etc.) that are encountered in the course of executing the base algorithm 402. The AI-based QoS engine 300 learns from these situations 406 and adjusts the initial quality-of-service priorities to more optimally handle the situations 406 to create a new normalized algorithm 408. This normalized algorithm 408 may then become the new base algorithm 402 for the AI-based QoS engine 300. The AI-based QoS engine 300 further refines and optimizes the base algorithm 402 by repeating the three-tiered algorithm 400.

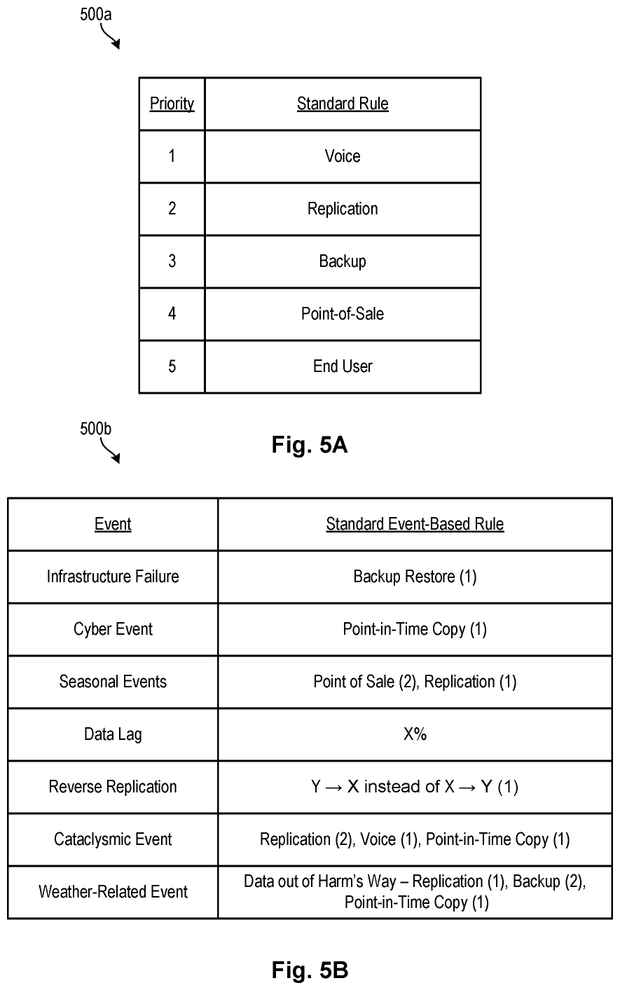

FIGS. 5A and 5B show various tables that may be used as part of a base algorithm 402. As indicated, the base algorithm 402 may be modified or refined from machine learning of the AI-based QoS engine 300. As shown, a first table 500a contains a standard rule that designates quality-of-service priorities (possibly initial quality-of-service priorities) for different data flows 306. In the illustrated example, voice data is provided the highest priority, followed by replication data, backup data, point-of-sale data, and end user data.

A second table 500b shows various event-based rules that may be executed in response to different events. The numbers represent the modified or adjusted priorities after the events have occurred. For example, in the event of an infrastructure failure, the AI-based QoS engine 300 may assign backup restore data flows 306 a highest quality-of-service priority so that recovery from the infrastructure failure may occur in an expeditious manner. Similarly, in response to a cyber event (e.g., virus, ransomware, etc.), the AI-based QoS engine 300 may assign point-in-time-copy data flows 306 a highest priority so that data is protected and any damage caused by the cyber event can be recovered from efficiently. Seasonal events may cause point-of-sale data to be prioritized to keep up with demand, and replication data to be prioritized to facilitate recovery in the event of a crash or failure during the seasonal events.

In the illustrated table 500b, “data lag” refers to how much lag there is in synchronizing applications or data across different sites. If the data lag rises above an acceptable threshold, the AI-based QoS engine 300 may reprioritize data flows 306 so that the data lag is brought back under the threshold. “Reverse replication,” by contrast, may refer to situations where data needs to be replicated or copied back to an initial site to recover data that has been lost or applications that have failed at the initial site. In such cases, the AI-based QoS engine 300 may prioritize data that is replicated back to the initial site.

In the event of a cataclysmic event, the AI-based QoS engine 300 may prioritize replication, voice, and point-in-time-copy data flows 306. Similarly, in the event of a weather-related event, the AI-based QoS engine 300 may attempt to move data out of harm's way. For example, the AI-based QoS engine 300 may prioritize replication, backup, and/or point-in-time-copy data flows 306 to make sure data is protected. The rules presented in FIGS. 5A and 5B are presented simply by way of example and not limitation.

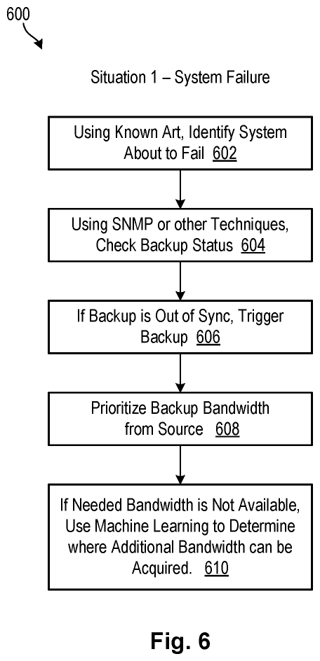

Referring to FIG. 6, a flow diagram is illustrated that shows an exemplary scenario for dynamically adjusting quality-of-service tags in response to a system failure. Using known art, the method 600 initially identifies 602 a system (e.g., host system, storage system, storage device, application, etc.) that is about to fail. Using SNMP or other techniques, the method 600 checks 604 the backup status of the system. If backups are out of synchronization, the method 600 triggers 606 a backup of data or applications on the system. In doing so, the method 600 prioritizes 608 backup data flows 306 originating from the system or other related sources. This may be accomplished by modifying quality-of-service tags associated with the data flows 306.

If not enough bandwidth is available to accommodate the higher-priority backup data flows 306, the method 600 may use 610 machine learning to determine where additional bandwidth can be acquired. Stated otherwise, the method 600 may use real-time and historical machine-learned usage data to understand which applications, technologies, and business processes can be de-prioritized to acquire additional bandwidth. For example, if point-in-time-copy, backup, or replication data flows 306 for other devices are synchronized and within lag limits, it may be possible to take bandwidth from these data flows 306 to dedicate to the higher-priority backup data flow 306 for the system that is about to fail. Similarly, if weather events or failures can be predicted for other devices such that data and/or applications on these devices are deemed to be safe, it may be possible to slow down backups, point-in-time-copies, etc. for the other devices so that additional bandwidth can be dedicated to the system that is about to fail.

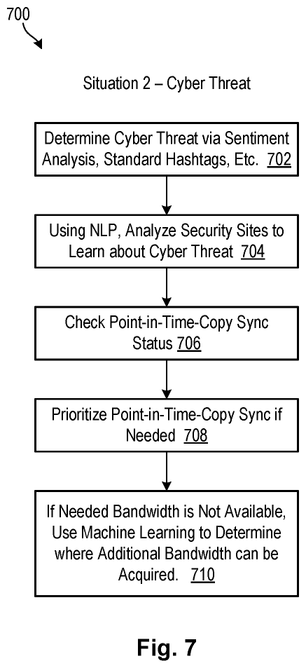

Referring to FIG. 7, a flow diagram is illustrated that shows an exemplary scenario for dynamically adjusting quality-of-service tags in response to a cyber threat. As shown, the method 700 initially determines 702, using sentiment analysis, standard hashtags, etc., whether a cyber threat is imminent and/or heading in the direction of system components of interest. If so, the method 700 uses 704 natural language processing to analyze 704 security sites and other information sources to learn about the cyber threat (behavior, danger level, etc.) and possible defenses (patches, preventative measures, etc.) for dealing with the cyber threat. The method 700 also checks 706 point-in-time-copy synchronization status for potentially affected systems. If point-in-time copies are not synchronized and up-to-date, the method 700 prioritizes 708 data flows 306 related to the point-in-time copies. If not enough bandwidth is available to accommodate the point-in-time-copy data flow 306 for the component subject to the cyber threat, the method 700 may use 710 machine learning to determine where additional bandwidth can be acquired, as described in association with FIG. 6. In certain cases, the method 700 may reduce the quality-of-service priorities of other data flows 306 to provide additional bandwidth to the point-in-time-copy data flow 306 as long as bandwidth of these other data flows 306 does not fall outside acceptable limits.

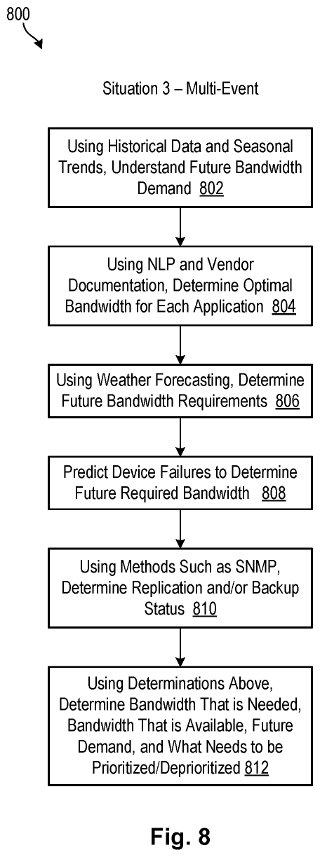

Referring to FIG. 8, a flow diagram is illustrated that shows an exemplary scenario for dynamically adjusting quality-of-service tags for multiple events (e.g., weather, cyber threats, seasonal demands, device failures, etc.) As shown, the method 800 initially determines 802, using historical data and seasonal trends, for example, future bandwidth demand. Using natural language processing of vendor specifications/documentation, the method 800 determines 804 optimal and/or acceptable bandwidth for each application. Using weather forecasting, the method 800 determines 806 future bandwidth that will be required for each application. The method 800 also predicts 808 device failures to determine future bandwidth requirements. Using techniques such as SNMP, the method 800 determines 810 replication and/or backup status for the applications 206. Using the determinations above, the method 800 determines 812 the bandwidth that will be needed, the bandwidth that is available, future demand for bandwidth, and consequently what data flows 306 need to be prioritized/deprioritized and when they need to be prioritized/deprioritized so that they can be adjusted accordingly.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for dynamically modifying quality of service tags for a plurality of data flows, the method comprising:
determining current bandwidth utilization for each of a plurality of data flows over a network;
determining acceptable bandwidth utilization for each of the plurality of data flows;
receiving external information that, based on one or more rules, changes quality of service priorities for one or more of the data flows; and
dynamically adjusting quality-of-service tags for data packets associated with the data flows based on the external information, such that current bandwidth utilization is altered for at least one data flow of the plurality of data flows without violating acceptable bandwidth utilization for each of the plurality of data flows.

2. The method of claim 1, wherein the external information is real-time information.

3. The method of claim 1, wherein the external information is one or more of weather information, disaster information, cyber-event information, data vulnerability information, component failure information, risk information, seasonal trend information, toolset information, OEM best practice information, business need information, historical usage information, network traffic information, latency information, and natural language processing information.

4. The method of claim 1, wherein the data flows are associated with one or more of data backup flows, data replication flows, point-of-sale transaction flows, database synchronization flows, database restoration flows, application synchronization flows, application restoration flows, audio data flows, video data flows, end-user data flows, and virtual-machine transfer flows.

5. The method of claim 1, wherein dynamically adjusting the quality-of-service tags comprises dynamically configuring at least one network component to adjust the quality-of-service tags.

6. The method of claim 1, wherein dynamically adjusting the quality-of-service tags comprises using a designated technology to dynamically adjust the quality-of-service tags, wherein the designated technology is selected from the group consisting of artificial intelligence, natural language processing, and machine learning.

7. The method of claim 1, further comprising repeating the method to iteratively adjust the quality-of-service tags.

8. A computer program product for dynamically modifying quality of service tags for a plurality of data flows, the computer program product comprising a computer-readable storage medium having computer-usable program code embodied therein, the computer-usable program code configured to perform the following when executed by at least one processor:
determine current bandwidth utilization for each of a plurality of data flows over a network;
determine acceptable bandwidth utilization for each of the plurality of data flows;
receive external information that, based on one or more rules, changes quality of service priorities for one or more of the data flows; and
dynamically adjust quality-of-service tags for data packets associated with the data flows based on the external information, such that current bandwidth utilization is altered for at least one data flow of the plurality of data flows without violating acceptable bandwidth utilization for each of the plurality of data flows.

9. The computer program product of claim 8, wherein the external information is real-time information.

10. The computer program product of claim 8, wherein the external information is one or more of weather information, disaster information, cyber-event information, data vulnerability information, component failure information, risk information, seasonal trend information, toolset information, OEM best practice information, business need information, historical usage information, network traffic information, latency information, and natural language processing information.

11. The computer program product of claim 8, wherein the data flows are associated with one or more of data backup flows, data replication flows, point-of-sale transaction flows, database synchronization flows, database restoration flows, application synchronization flows, application restoration flows, audio data flows, video data flows, end-user data flows, and virtual-machine transfer flows.

12. The computer program product of claim 8, wherein dynamically adjusting the quality-of-service tags comprises dynamically configuring at least one network component to adjust the quality-of-service tags.

13. The computer program product of claim 8, wherein dynamically adjusting the quality-of-service tags comprises using a designated technology to dynamically adjust the quality-of-service tags, wherein the designated technology is selected from the group consisting of artificial intelligence, natural language processing, and machine learning.

14. The computer program product of claim 8, wherein the computer-usable program code is further configured to iteratively adjust the quality-of-service tags.

15. A system for dynamically modifying quality of service tags for a plurality of data flows, the system comprising:
at least one processor;
at least one memory device operably coupled to the at least one processor and storing instructions for execution on the at least one processor, the instructions causing the at least one processor to:
determine current bandwidth utilization for each of a plurality of data flows over a network;
determine acceptable bandwidth utilization for each of the plurality of data flows;
receive external information that, based on one or more rules, changes quality of service priorities for one or more of the data flows; and
dynamically adjust quality-of-service tags for data packets associated with the data flows based on the external information, such that current bandwidth utilization is altered for at least one data flow of the plurality of data flows without violating acceptable bandwidth utilization for each of the plurality of data flows.

16. The system of claim 15, wherein the external information is real-time information.

17. The system of claim 15, wherein the external information is one or more of weather information, disaster information, cyber-event information, data vulnerability information, component failure information, risk information, seasonal trend information, toolset information, OEM best practice information, business need information, historical usage information, network traffic information, latency information, and natural language processing information.

18. The system of claim 15, herein the data flows are associated with one or more of data backup flows, data replication flows, point-of-sale transaction flows, database synchronization flows, database restoration flows, application synchronization flows, application restoration flows, audio data flows, video data flows, end-user data flows, and virtual-machine transfer flows.

19. The system of claim 15, wherein dynamically adjusting the quality-of-service tags comprises dynamically configuring at least one network component to adjust the quality-of-service tags.

20. The system of claim 15, wherein dynamically adjusting the quality-of-service tags comprises using a designated technology to dynamically adjust the quality-of-service tags, wherein the designated technology is selected from the group consisting of artificial intelligence, natural language processing, and machine learning.
